(19) United States
(12) Patent Application Publication
(10) Pub. No.: US 2025/0350809 A1
(43) Pub. Date: Nov. 13, 2025

(54) PROVIDING CONTEXTUAL EDUCATIONAL CONTENT FOR A CONTENT RECEIVER USING ARTIFICIAL INTELLIGENCE

(71) Applicant: DISH Network L.L.C., Englewood, CO (US)

(72) Inventor: Morgan Kirby, Englewood, CO (US)

(21) Appl. No.: 18/657,557

(22) Filed: May 7, 2024

(51) Int. Cl. H04N 21/485; H04N 21/466; H04N 21/472

(52) U.S. Cl. CPC H04N 21/485; H04N 21/4667; H04N 21/47202

(57) ABSTRACT

Techniques for providing contextual educational content for a content receiver using artificial intelligence are disclosed. A determination is made to provide educational content regarding a content receiver to a user. Contextual information associated with content currently displayed to the user using the content receiver is obtained. A prompt for an educational artificial intelligence model is created based on the contextual information and provided to the educational artificial intelligence model. The educational content is displayed to the user based on output from the educational artificial intelligence model. The educational artificial intelligence model is trained based on user input received in response to displaying the educational content.

### BACKGROUND

Modern content receivers offer more functionality than ever before, allowing viewers to watch multiple content programs at the same time, create and share digital video recorder (DVR) recordings, watch DVR recordings on multiple devices, etc. Such content receivers can also be complex and pose difficulties for viewers to install and/or operate.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for providing contextual educational content for a content receiver using artificial intelligence in accordance with embodiments described herein.

FIG. 2 illustrates a context diagram of a non-limiting example of a system that provides contextual educational content for a content receiver using artificial intelligence in accordance with embodiments described herein.

FIG. 3 illustrates a logical flow diagram showing an overview process for providing contextual educational content for a content receiver using artificial intelligence in accordance with embodiments described herein.

FIG. 4 is a use-case illustration of a user interacting with contextual educational content in accordance with embodiments described herein.

FIG. 5 illustrates a logical flow diagram showing a process for training an artificial intelligence model based on user feedback in accordance with embodiments described herein.

FIG. 6 illustrates a logical flow diagram showing a process for creating a prompt requesting contextual educational content from an artificial intelligence model in accordance with embodiments described herein.

FIG. 7 illustrates a logical flow diagram showing at least one embodiment of a process for generating contextual educational content in accordance with embodiments described herein.

FIG. 8 shows a system diagram that describes examples of computing systems for implementing embodiments described herein.

### DETAILED DESCRIPTION

Modern content receivers' vast functionality enables users to perform many useful functions. The many interfaces, menus, and options available for content receivers, however, may also make it difficult for some users to operate their content receivers. For example, a user may receive a warning that their content receiver is out of storage and digital video recorder (DVR) recordings must be deleted. But the user may not know how to delete DVR recordings from the content receiver. Though educational information such as an instruction manual is typically available for the content receiver, many users are unable or unwilling to locate the educational information, understand the educational information, etc. Users may also be hesitant to make changes to their content receivers because they are not confident that they can undo the changes. Thus, the user may be left frustrated and unable to find an answer to their question about the content receiver. The frustrated user may proceed to call customer support to answer their question, or even call a technician to service the content receiver, which frequently does not need to be serviced. Thus, the relative difficulty of accessing educational information regarding the content receiver may incur substantial cost for both the user and entities associated with the content receiver.

Embodiments disclosed herein solve these disadvantages, at least in part, by providing contextual educational content for content receivers using artificial intelligence.

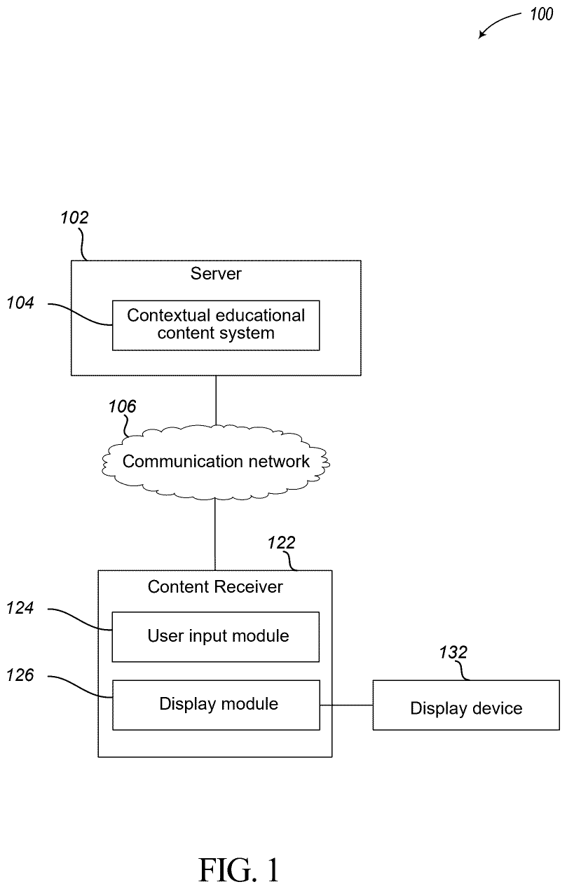

FIG. 1 illustrates a context diagram of an environment 100 for providing contextual educational content for a content receiver using artificial intelligence in accordance with embodiments described herein. The environment 100 includes a server 102, a content receiver 122, and a display device 132. The server 102, content receiver 122, or display device 132 may interact with each other or other devices using a communication network 106 which may include wired and wireless communication.

The content receiver 122 may include user input module 124 and display module 126, and is a device typically configured to provide content to a user, such as using display device 132. The content receiver 122 may receive user input requesting assistance with the content receiver 122 using user input module 124. The content receiver may provide an indication of the user input to server 102 via communication network 106.

Server 102 may include contextual educational content system 104, which automatically provides educational content using artificial intelligence in response to receiving the indication of user input from content receiver 122. For example, contextual educational content system 104 may generate an educational animation for replacing batteries in a remote control of the content receiver in response to receiving user input indicating that the user requires assistance with replacing the batteries of the remote control.

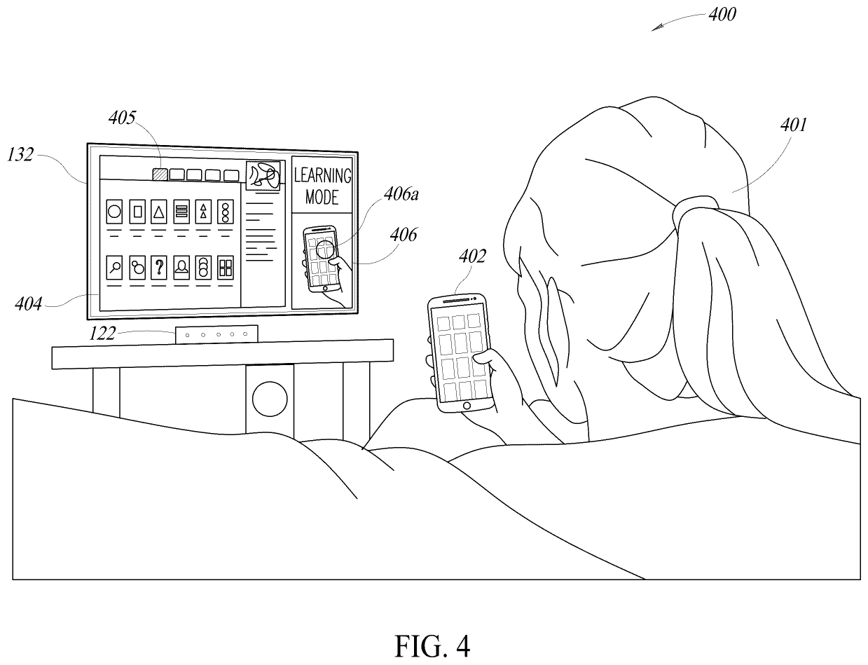

In some embodiments, the educational content is displayed using display device 132, such that the user may follow along with the educational content. The educational content may be displayed using a learning mode of the content receiver 122, wherein changes made by the user to the content receiver 122 while in learning mode may be reverted upon exit of learning mode. Learning mode is discussed in detail with respect to FIG. 4.

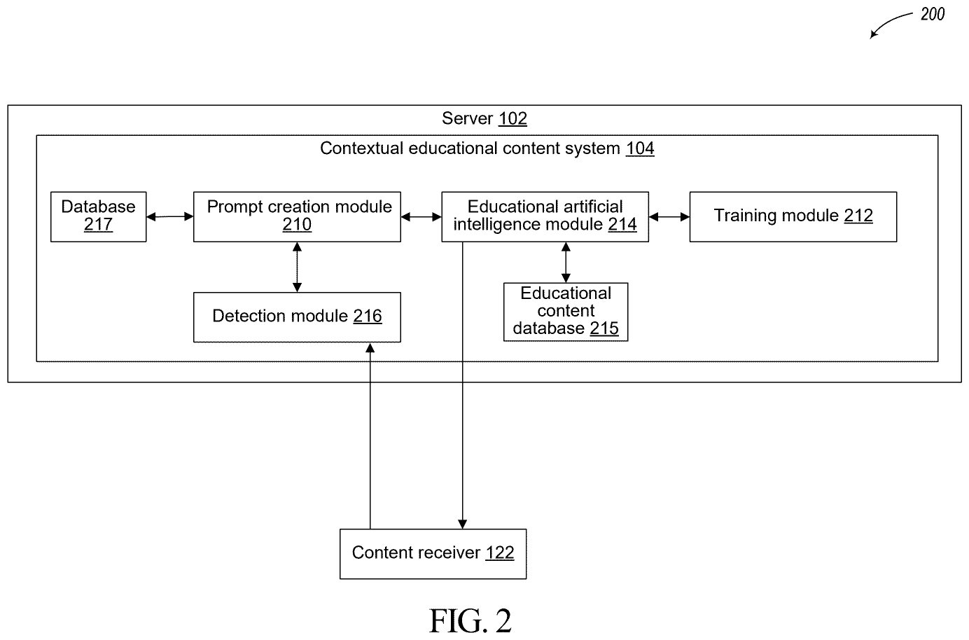

FIG. 2 illustrates a context diagram of a non-limiting embodiment of a system 200 that provides contextual educational content for a content receiver using artificial intelligence in accordance with embodiments described herein.

System 200 includes server 102 and content receiver 122. Server 102 may include contextual educational content system 104. Contextual educational content system 104 may include a prompt creation module 210, a training module 212, an educational artificial intelligence (AI) module 214, a detection module 216, a database 217, and an educational content database 215.

The contextual educational content system 104 is configured to provide educational content to the content receiver 122 for display to a user. The contextual educational content system receives a prompt, such as from content receiver 122, to provide educational content via content receiver 122. Contextual educational content system 104 may use detection module 216 to detect when a user requires assistance. For example, detection module 216 may receive a query from content receiver 122, such as “how do I delete recorded content?”. The query may be provided to prompt creation module 210, which generates a prompt to be provided to educational AI module 214. Educational AI module 214 uses the prompt to generate educational content that is responsive to the query. For example, educational AI module 214 may generate an educational animation that indicates how the user may delete recorded content. The educational content is provided to content receiver 122 to be displayed to the user. Content receiver 122 may then receive feedback from the user regarding the displayed educational content. The feedback may be provided to training module 212, which trains educational AI module 214 using the feedback. Thus, educational content provided to users may be improved over time based on user feedback about the educational content.

Prompt creation module 210 transforms information received, such as from content receiver 122, into a prompt for requesting relevant educational content from educational AI module 214. In some embodiments, prompt creation module 210 is configured to include configurable instructions in a prompt that define a format, contents, or other characteristics of the educational content to be provided by educational AI module 214. For example, the prompt creation module 210 may be configured to provide educational content in a consistent format to make the educational content easier to follow. Prompt creation module 210 may include a picture, text, or a combination thereof, that defines one or more features of the educational content. Prompt creation module 210 may produce a prompt that includes a picture of a remote control or smart phone that the user uses to interact with content receiver 122. Educational content provided to the user may therefore demonstrate how a device of the user may be used to interact with content receiver 122.

In some embodiments, prompt creation module 210 uses data in database 217 to create the prompt. Database 217 includes various content that may be relevant to answering user queries about content receiver 122. Prompt creation module 210 may include relevant content from database 217 in a prompt created for educational AI module 214. For example, database 217 may include educational content such as instruction manuals, call center or support chat transcripts, copies of various online support information, forum posts, social media content relating to troubleshooting a content receiver, etc. In various embodiments, database 217 is indexed by content receiver type, various keywords or phrases such as “turn off,” “delete,” etc. For example, when detection module 216 receives a user query asking how to turn off the content receiver 122, content associated with the phrase “turn off” may be included in a prompt created by prompt creation module 210 to provide educational artificial intelligence module 214 with relevant information.

Educational AI module 214 is used to provide contextual educational content. In some embodiments, educational AI module 214 includes one or more generative artificial intelligence models such as generative pre-trained transformer (GPT)-3.5, GPT-4, Claude, Perplexity AI, Google Bard, Sora, etc., or a combination thereof.

Generative artificial intelligence models (GAIs) are trained to create content in response to a prompt. In various embodiments, a GAI generates text, images, sounds, video, etc. in response to a prompt. GAIs such as Sora may be capable of generating high-definition video in response to a prompt that includes a picture, a video, text, or a combination thereof. For example, in response to the text prompt “an old man wearing purple overalls and cowboy boots taking a pleasant stroll in Mumbai, India during a beautiful sunset,” Sora generates a realistic video clip of an old man wearing purple overalls and cowboy boots taking a pleasant stroll in Mumbai, India.

Generative artificial intelligence models may also be used to generate text-based responses. Generative artificial intelligence models such as GPT-4 can generate text-based responses to prompts that include text, images, or a combination thereof. For example, in response to GPT-4 receiving a prompt requesting it to summarize a customer support interaction, GPT-4 generates a summary of the customer support interaction.

In some embodiments, the educational AI module uses a generative artificial intelligence model capable of generating images or video such as Sora to generate educational content. For example, the prompt creation module 210 may provide the educational AI module 214 with a diagram of a content receiver controller accessible to a user of content receiver 122, along with text-based instructions regarding operation of the content receiver controller that are relevant to the user query. The educational AI module then uses a generative artificial intelligence model capable of generating video to produce an animation of the content receiver controller to display to the user.

As discussed herein, text-based instructions used to generate the animation of the content receiver controller may be generated using a generative artificial intelligence model based on manuals, call center or customer support transcripts or data, help pages, or other information associated with the content receiver. For example, prompt creation module 210 may provide a generative artificial intelligence model with the user query and information associated with the user query and request the generative artificial intelligence model to create a prompt to provide to a generative AI capable of generating video content.

In some embodiments, educational AI module 214 uses the prompt to search educational content database 215 to determine whether educational content responsive to the prompt already exists. If educational content responsive to the prompt already exists in educational content database 215, the educational AI module 214 may provide the existing content to content receiver 122. When educational content responsive to the prompt does not already exist in educational content database 215, the educational AI module 214 may generate the educational content responsive to the prompt as described herein. The prompt and the educational content may then be stored in the educational content database for future use.

While the educational AI module 214 is depicted in FIG. 2 as implemented using server 102, the disclosure is not so limited. In various embodiments, the educational AI module 214, or a portion thereof, is implemented using other computing devices. For example, educational artificial intelligence module 214 may be implemented using content receiver 122 or another computing device. In some embodiments, the educational AI module 214 interfaces with an application programming interface of a generative artificial intelligence service.

Detection module 216 determines whether the user of the content receiver 122 requires assistance. In some embodiments, such as when the user requests help verbally, detection module 216 may forward the request to prompt creation module 210. In some embodiments, however, detection module 216 may determine that the user requires assistance without receiving such a request. For example, the detection module may compare data received from the content receiver 122 to one or more rules to determine whether the user requires assistance. The one or more rules may be based on various action or inaction of the user that indicates that the user requires assistance. For example, if the user has not provided input after a threshold amount of time after being provided with a settings menu, a rule may indicate that the user requires assistance. The threshold amount of time may be a configurable amount of time such as 5, 10, 30, or 60 seconds. In some embodiments, a rule to determine whether the user requires assistance depends on content being displayed to the user. For example, a user at a menu deciding which content to watch may be less likely to require assistance, and a rule may only indicate that the user requires assistance in this context when the user provides several commands in rapid succession. When a user is within a settings sub-menu, however, the user may be more likely to require assistance. Accordingly, a rule may indicate that the user requires assistance after only a few seconds of inaction. In some embodiments, several rules may indicate that the user requires assistance in a context.

In some embodiments, detection module 216 periodically queries content receiver 122 for information relevant to whether the user requires assistance. For example, the detection module may query the content receiver 122 every 5, 10, 30, etc. seconds for information regarding actions of the user or a state of the content receiver 122, which is analyzed to determine whether the user requires assistance.

In some embodiments, the content receiver 122 is configured to automatically provide the detection module 216 with information regarding actions of the user or the state of the content receiver 122 to determine whether the user requires assistance.

In some embodiments, detection module 216 includes an artificial intelligence model that is trained using training data that includes information associated with actions of users or states of content receivers at times users request assistance. The training data may also include information associated with actions of users or states of content receivers when users do not request assistance. In some embodiments, the training data is labeled based on whether the user requested assistance, and the artificial intelligence model is trained with the labeled training data via supervised learning. Thus, detection module 216 is trained to determine whether actions of the user or states of the content receiver that are provided as input are associated with a request for assistance. When the detection module 216 receives information including such an action or state of the content receiver and determines that the user requires assistance, detection module 216 may automatically provide the information to the prompt creation module 210 such that educational content may be provided to the user without the detection module 216 receiving an explicit request for assistance.

Training module 212 is used to train educational AI module 214 to improve its generation of educational content. In various embodiments, the training module 212 implements any known method for training educational AI module 214 such as prompt tuning, finetuning, training output layers, adapters, etc. In some embodiments, training module 212 trains educational AI module 214 to be used in connection with providing content for a user. For example, the user may provide feedback that text included in generated educational content is too small to be legible. In some embodiments feedback or other preferences are stored. Subsequent prompts for educational content to be provided to the user may then include a statement including the feedback such that larger text is used in subsequent educational content provided to the user.

In some embodiments, training module 212 trains educational AI module 214 for use with various users. For example, when a user indicates that generated content is irrelevant, this information may be applicable to generating content for other users. When the user indicates that educational content is irrelevant to their question, this information may be used to train educational AI module 214 or modify prompt creation module 210 such that the more relevant educational content may be provided.

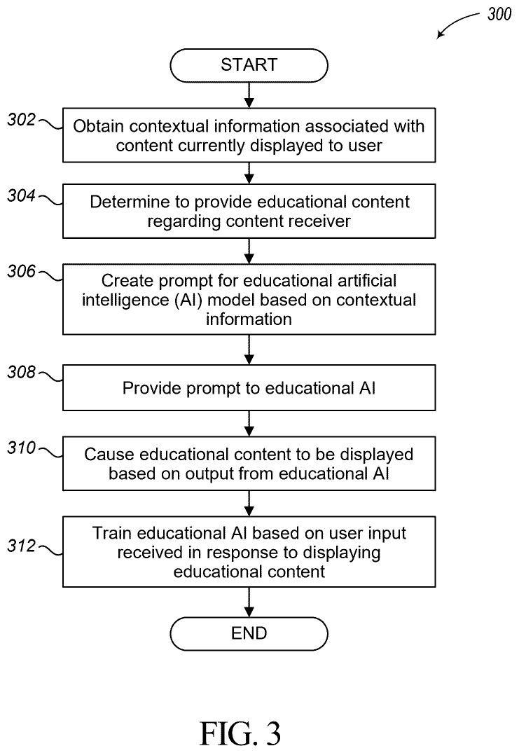

The operation of certain aspects will now be described with respect to FIGS. 3, 5, 6, and 7. Processes 300, 500, 600, and 700 are described in conjunction with FIGS. 3, 5, 6, and 7, respectively, and may be implemented individually or collectively by one or more processors or executed individually or collectively via circuitry on one or more computing devices, such as server 102 in FIG. 1.

FIG. 3 illustrates a logical flow diagram showing one embodiment of a process 300 for providing contextual educational content for a content receiver using artificial intelligence in accordance with embodiments described herein.

Process 300 begins, after a start block, at block 302, where contextual information associated with the content receiver is obtained.

In some embodiments, the contextual information includes information associated with a state of the content receiver. The information associated with the state of the content receiver may include content currently displayed by the content receiver such as a menu in which the user is currently navigating, a currently displayed notification including a warning, advertisement, windowed content, etc. In some embodiments, the information associated with the state of the content receiver includes diagnostic information regarding functionality of various components of the content receiver; errors the content receiver is experiencing; a temperature, utilization, or other performance indicator of one or more components, etc. In various embodiments, the information associated with the state of the content receiver may include any information relating to the content receiver, content that is being displayed or may be displayed using the content receiver, or other devices associated with the content receiver such as a remote control or display device.

In some embodiments, the contextual information includes information regarding an action of the user. Information regarding the action of the user may include a time elapsed since the user last provided input, a number or frequency of actions taken by the user, a sound made by the user, a threshold amount of time spent by the user navigating a menu, demographic information of the user, a type of command issued by the user using a controller for the content receiver, etc. For example, it may be determined to display educational content when the user has provided a large number of inputs or when the user has been navigating a menu for more than 5, 10, 30, etc. seconds. After block 302, process 300 continues to block 304.

At block 304, a determination to provide educational content regarding the content receiver is made. The determination may be made by comparing the contextual information to one or more rules. For example, the one or more rules may indicate that the user requires assistance when the user has been navigating a settings menu for more than a threshold period of time. In some embodiments, the one or more rules indicate that the user requires assistance when the user has provided a number or frequency of inputs above a threshold. The threshold may be number of inputs per unit time, such as 5 inputs per second and may be user-configurable, such as by a user interface displayed using the content receiver.

As described herein, the determination may be made using an artificial intelligence model. For example, the AI model may be trained to detect whether the contextual information is associated with the user requiring educational content.

In some embodiments, the determination is made based on an explicit request for assistance. For example, a verbal request for assistance may be received from the user via a microphone that is communicatively coupled to the content receiver.

In some embodiments, in response to determining to provide educational content, the content receiver is caused to display an interface to the user requesting the user to confirm whether the user requires assistance. In some embodiments, the interface displays one or more user-selectable options for assistance based on the contextual information. For example, there may be several options for educational content related to a given settings menu. In some embodiments, the one or more options for assistance correspond to one or more prompts for the educational AI model created based on the contextual information, as described at least in block 306. After block 304, process 300 continues to block 306.

At block 306, a prompt for an educational AI model is created based on the contextual information. In some embodiments, the prompt is created using additional information identified using the contextual information. The additional information may be obtained by searching for one or more terms of the contextual information in a database. For example, the database may include a variety of information such as manuals associated with the content receiver, call center or customer support transcripts or data, help pages, or other documentation associated with the content receiver. Information in the database that is relevant to the contextual information may be included in the prompt. For example, when the contextual information includes a user query such as “How do I change the channel?”, the database may be searched for documents that include one or more terms in the user query. In various embodiments, any known search algorithm may be used to locate additional information. In some embodiments, the contextual information is used to search for additional information on the internet. In some embodiments, the additional information or a portion thereof is included verbatim in the prompt. In some embodiments, a summary of the additional information is included in the prompt. The summary of the additional information may be generated using the additional information as input to a generative artificial intelligence model.

In some embodiments, the additional information is based on contextual information such as a location or a demographic of the user. Users in various regions may speak different languages or dialects. For example, in some regions of the United States, a remote control is colloquially referred to as a “tater”. Thus, in some embodiments, information regarding the meaning of various terms such as “tater” that are specific to a region of the user is included in the prompt. For example, transcripts of call center data from the region of the user may be included in the prompt.

In some embodiments, the prompt includes a command for the educational AI model to generate educational content based on demographic information of the user. For example, when the user is a child, the user may require more detailed instructions, simpler language, etc. to follow. Thus, the prompt may include a command indicating demographic information about the user and a request for the educational content to be generated such that it is interpretable to the user.

In some embodiments, the prompt includes content that indicates a format or style of the educational content. For example, an image or animation of existing educational content may be included as example formatting for the educational AI model to follow in creating the educational content. In some embodiments, the prompt includes a natural language command instructing the educational AI model to create the educational content in the same format or style as the image or animation of the existing educational content. In this way, educational content having a consistent format or style may be produced. After block 306, process 300 continues to block 308.

At block 308, the prompt is provided to the educational AI model. After block 308, process 300 continues to block 310.

At block 310, educational content is displayed based on output from the educational AI model. In some embodiments, the educational content is displayed alongside the content, as depicted in Display of the educational content is described in detail with respect to FIG. 4. After block 310, process 300 continues to block 312.

At block 312, the educational AI model is trained based on user input received in response to displaying the educational content.

In various embodiments, the user input includes user audio. The user audio may include audio corresponding to a time before the educational content is displayed, while the educational content is displayed, after the educational content is displayed, or a combination thereof. In various embodiments, a microphone of controller 402, content receiver 122, or display device 132 may be used to obtain the user audio. In some embodiments, sentiment analysis techniques may be used to determine a sentiment of the user audio. The generated educational content may be labeled based on the sentiment of the user audio, such that the educational AI model is trained by supervised learning using the educational content labeled by the corresponding sentiment. Thus, the educational AI model may be trained to provide content associated with user feedback that has positive sentiment.

In some embodiments, the user input is solicited, such as by displaying a request for user input to the user. The request for user input may include displaying one or more sentiment indicators for the user to select such as a smiling face, frowning face, neutral face, etc. for selection by the user. The generated educational content may then be labeled based on the selected sentiment indicator, and the educational AI model is trained by supervised learning using the educational content labeled by the selected sentiment indicator.

In some embodiments, the educational AI model is trained using prompt tuning. Prompt tuning refers to modifying future prompts provided to a generative AI to change the generative AI's performance. For example, when a user provides positive feedback regarding first educational content produced in response to a first query, a future prompt created in response to a second query that is similar to the first query may include information based on the first educational content. Thus, the educational AI model may be more likely to reproduce educational content that is similar to educational content that received positive feedback.

In some embodiments, one or more output layers of the educational AI model are trained based on additional task-specific information (i.e., “finetuning”). Generative artificial intelligence base models such as GPT-4 are typically trained using vast datasets from a variety of sources. But the base generative AI model may not be trained using task-specific training data. For example, GPT-4 may not be trained on information regarding various content receivers or content receiver controllers. The generative AI base model may therefore be trained using task-specific material such as manuals associated with the content receiver. In some embodiments, weights corresponding to one or more output layers are trained, while weights corresponding to the hidden layers of the base generative AI model are held constant, so they are not modified during training. Thus, relationships learned by the generative AI during its initial training may be preserved and adapted for use with the relevant task by training the output layers.

In some embodiments, the educational AI model is trained using reinforcement learning from human feedback (RLHF).

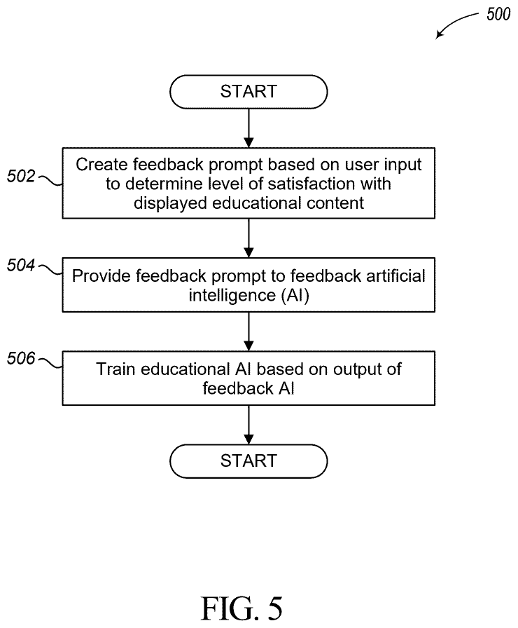

In some embodiments, the educational content is stored based on the user input received. When the user input is negative, the educational content may be discarded so that it is not displayed in response to a future request. When the user input is positive, the educational content may be stored, such as in educational content database 215, to be displayed in connection with a future request so that the educational content does not need to be re-generated. Training the educational AI model is further discussed with respect to FIG. 5. After block 312, process 300 ends at an end block.

FIG. 4 is a use-case illustration 400 of a user interacting with contextual educational content in accordance with embodiments described herein.

User 401 uses controller 402 to interact with content receiver 122. Content receiver 122 displays content using display device 132. In FIG. 4, learning mode is depicted, whereby educational content 406 is displayed alongside content 404. Content 404 is a menu associated with selected menu tab 405.

In some embodiments, educational content 406 shows how controller 402 may be used to interact with content 404 displayed using content receiver 122. Action indicator 406a indicates an action to be taken by user 401 with respect to controller 402 to interact with content 404. For example, action indicator 406A may highlight an icon or button on controller 402 for the user 401 to press to accomplish an action.

In various embodiments, educational content 406 may be displayed over a portion of content 404, in split-screen with content 404, etc. In some embodiments, educational content 406 is provided as audio instructions. In some such embodiments, educational content 406 is not displayed using display device 132. In some embodiments, action indicator 406a is displayed, in addition to or instead of display using display device 132, using a display of controller 402.

Educational content 406, as shown in FIG. 4, includes text indicating that the content receiver 122 is in “learning mode.” While in learning mode, changes made to the state of content receiver 122 may be discarded upon exiting learning mode, and a state of the content receiver 122 saved immediately before learning mode is entered may be restored. Educational content 406 may guide user 401 through deleting recorded content on content receiver 122 in learning mode. While in learning mode, changes to the state of content receiver 122 may be reflected in content 404, allowing the user 401 to see the effect their input has on the state of content receiver 122. This may allow the user 401 to gain confidence in controlling content receiver 122 before committing to changing the state of constant receiver 122.

In some embodiments, educational content 406 may be advanced in response to the content receiver 122 receiving input that corresponds to an action indicated by educational content 406. For example, when action indicator 406a indicates that the user is to provide an input and the user provides the input, learning mode 406a may be advanced to a next action.

In various embodiments, the content receiver 122 may exit learning mode in response to all of educational content 406 being displayed, receiving a command via controller 402, etc.

In some embodiments, before exiting learning mode, content receiver 122 solicits input regarding whether changes to the state of the content receiver 122 made in learning mode should be applied or discarded. For example, when the user 401 determines that actions taken in learning mode resulted in a desirable state of the content receiver 122, such as by effecting a desired settings change, the user may prefer to apply the state of the content receiver 122 as modified during learning mode rather than revert the state and repeat the steps to effect the change. When the user 401 determines that actions taken in learning mode resulted in an undesirable state of the content receiver 122, the changes may be discarded based on input from user 401.

In some embodiments, the content receiver is configured to discard changes made in learning mode by default. The content receiver may automatically discard the changes a configurable timeout period such as 3, 5, or 10 seconds after learning mode is exited. In some embodiments, the content receiver is configured to apply the changes made in learning mode by default after the configurable timeout period.

When the content receiver 122 receives input that indicates that the changes made in learning mode are to be applied, content receiver 122 may exit learning mode but remain in a same state. When the content receiver 122 receives input that indicates the changes made in learning mode are not to be applied, content receiver 122 does not apply actions taken by the user 401 learning mode to alter its state. Rather, the state of the content receiver 122 before learning mode was initiated may be restored, such that content 404 reflects a same state as before learning mode was initiated. Display of educational content 406 may be discontinued upon receiving input regarding whether the changes made while in learning mode but should be applied or discarded. In some embodiments, the content receiver 122 may continue to store the backup state after learning mode is discontinued, such that backup state may be restored in the future.

While controller 402 is depicted as a smart phone in FIG. 4, the disclosure is not so limited. In in various embodiments, controller 402 is a content receiver remote control, a laptop computer, a desktop computer, a smart watch or other wearable device, etc.

While content 404 is depicted as a menu in FIG. 4, the disclosure is not so limited. In various embodiments, learning mode may be displayed alongside any content including a television show, streaming content, etc. For example, the user 401 may request educational content about setting parental controls while content 404 is sports game. Thus, educational content 406 does not necessarily correspond to content 404.

FIG. 5 illustrates a logical flow diagram showing one embodiment of a process 500 for training an artificial intelligence model using a feedback artificial intelligence model based on user feedback in accordance with embodiments described herein. In some embodiments, block 312 of FIG. 3 employs embodiments of process 500 to train the educational AI model based on user input received in response to displaying the educational content.

Process 500 begins, after a start block, at block 502, where a feedback prompt is created based on user input to determine a level of satisfaction with displayed educational content. The user input may be obtained as described with respect to block 312 of FIG. 3.

The user input is used to create a feedback prompt to be provided to a feedback artificial intelligence model (i.e., a feedback AI). In some embodiments, the feedback prompt requests the feedback AI to perform sentiment analysis of the user input. In some embodiments, the feedback prompt includes instructions to provide the sentiment analysis using a configurable scale such as 1 to 10, 1 to 100, etc. The feedback prompt may also include the user input in text format, audio format, video format, or any combination thereof.

In some embodiments, the feedback prompt includes instructions for the feedback AI to format its output as instructions to improve performance of the educational AI model. For example, if the user input includes voice input stating “the animation is too fast,” the feedback AI may format its output as an instruction to the educational AI model such as “please make sure that each step in the animation is displayed for at least five seconds.”

In some embodiments, the feedback prompt specifies that a response provided by the feedback AI is to be formatted using a selected embedding format that is interpretable by the educational AI model. After block 502, process 500 continues to block 504.

At block 504, the feedback prompt is provided to a feedback artificial intelligence model (i.e., the “feedback AI”). After block 504, process 500 continues to block 506.

At block 506, the educational AI model is trained based on the output of the feedback AI. In some embodiments, the educational AI model is trained using prompt tuning. Prompt tuning refers to modifying future behavior of the educational AI model by modifying future prompts provided to the educational AI model. For example, when the output of the feedback AI indicates that the user was unsatisfied with the educational content because it was irrelevant, an embedding indicating that the educational content was irrelevant given the provided contextual information may be included in future prompts created for the educational AI model having contextual information similar to the provided contextual information. Thus, user prompts having similar contextual information may be less likely to be provided with the irrelevant educational content. After block 506, process 500 ends at an end block.

In some embodiments, the feedback AI is part of the educational AI model, and the feedback prompt is provided to the educational AI model to improve its own performance. In some such embodiments, the educational AI model produces a summary of the feedback prompt, which may be stored with corresponding contextual information, for example, in database 217. The summary may then be included in future prompts having similar contextual information as described herein.

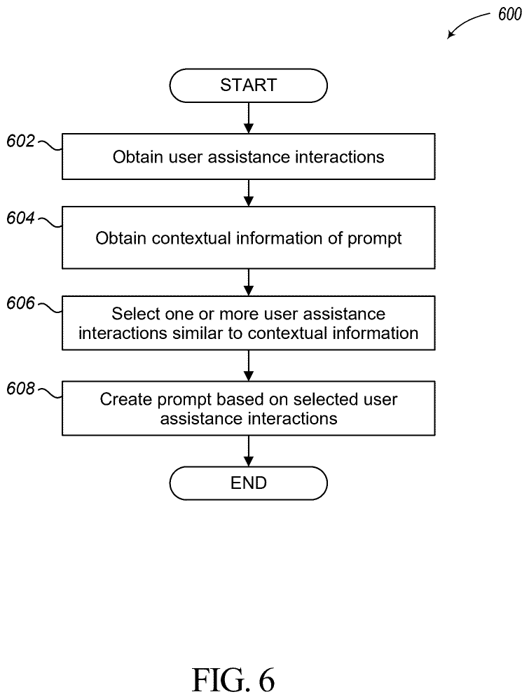

FIG. 6 illustrates a logical flow diagram showing one embodiment of a process 600 for creating a prompt requesting contextual educational content from an artificial intelligence model using user assistance interactions in accordance with embodiments described herein. In some embodiments, block 306 of FIG. 3 employs embodiments of process 600 to create a prompt for an educational artificial intelligence model based on contextual information. As discussed herein, the educational artificial intelligence model may not be trained on all relevant data that is available. Embodiments of process 600 enable the educational artificial intelligence model to access information that may be relevant to responding to a user query.

Process 600 begins, after a start block, at block 602, where user assistance interactions are obtained. In various embodiments, the user assistance interactions may include call center interactions, help chat interactions, interactions with the contextual educational content system, etc. In some embodiments, the user assistance interactions include a text-based transcript, an audio or video recording, etc. For example, the user assistance interactions may include text-based transcripts of call center interactions, wherein the user is requesting assistance with a content receiver. In some embodiments, assistance interactions of various formats may be obtained, such as text-based transcripts and audio-based transcripts.

In some embodiments, the assistance interactions are normalized into text, such as by extracting a text-based transcript from audio. After block 602, process 600 continues to block 604.

At block 604, contextual information for a prompt is obtained. In various embodiments, block 604 employs embodiments of block 302 of FIG. 3 to obtain the contextual information for the prompt. As described herein, the contextual information may include various information relating to the state of the content receiver or the actions of a user. For example, the contextual information may include a model type of the content receiver, an input device being used to control the content receiver, an indication of content being displayed by the content receiver, actions of the user, etc. After block 604, process 600 continues to block 606.

At block 606, one or more user assistance interactions similar to the contextual information are selected. In some embodiments, the one or more user assistance interactions are selected by comparing the contextual information to corresponding information of the user assistance interactions to identify user assistance interactions that occurred in contexts similar to the contextual information. For example, when the contextual information indicates a model of the content receiver, user assistance interactions involving the model of content receiver may be selected. When the contextual information indicates that content such as a menu is being displayed by the content receiver, the one or more user assistance interactions may be selected because they involve the menu.

In various embodiments, any portion of the contextual information may be used to select the one or more similar user assistance interactions. A word, a phrase, or any other portion of the contextual information may be searched against the user assistance interactions to identify similar user interactions. In general, any known search algorithm may be used to identify user assistance interactions that are similar to the contextual information.

In some embodiments, the contextual information is only compared to corresponding information for user assistance interactions that resulted in positive user feedback. For example, if the contextual information specifies a type of content receiver, only user assistance interactions involving the type of content receiver and that resulted in positive feedback from the corresponding user may be considered. An indication of whether the user assistance interaction resulted in positive feedback may be stored as metadata that corresponds to user assistance interaction data, one or more fields in a database storing the user assistance interaction data, etc.

In some embodiments, the contextual information, the corresponding information regarding the user assistance interactions, or both, may be embeddings. An embedding refers to information that has been compressed into a relatively low-dimension embedding space. For example, natural language text such as “water buffalo” may be transformed into a number vector such as [0.004, 0.002, 0.049, . . . , −0.037] using an embedding model. Embedding models may be configured such that similar natural language text is also similar when in the embedding space. Thus, embeddings may be compared to determine whether an embedding of the contextual information and an embedding of the corresponding information are similar.

In some embodiments, call center interaction embeddings based on a plurality of call center interactions are obtained. An embedding of the contextual information is created. The embedding of the contextual information is compared to each call center interaction embedding. One or more call center interaction embeddings of the plurality of call center interaction embeddings are selected to include in the prompt based on the comparison. A prompt for the educational AI model is then created based on the one or more call center interactions.

In some embodiments, educational content regarding the content receiver is obtained. An embedding of the educational content is created, and a prompt for the educational AI model is created using the embedding of the educational content. Because many generative AI models that may be included in the educational AI model have prompt character limits, including embeddings of educational content may allow for more relevant information to be included in the prompt. After block 606, process 600 continues to block 608.

At block 608, a prompt is created based on the selected user assistance interactions. In some embodiments, the prompt may include a full transcript of one or more of the selected user assistance interactions. For example, a transcript of an entire call center interaction identified as similar to the contextual information may be included in the prompt. In some embodiments, a summary of a selected user assistance interaction is included in the. In some embodiments, the summary of the selected user assistance interaction may be generated using the educational AI model. For example, a prompt including test of a user assistance interaction may be provided to the educational AI model with a command to summarize the assistance provided in the user assistance interaction into a summary of under 10, 20, or 50, etc. words. In some embodiments, the summary is stored such that it may be used in connection with creating a future prompt. The prompt may include a command for the generative artificial intelligence model to create a response based on the selected user assistance interactions. After block 608, process 600 ends at an end block.

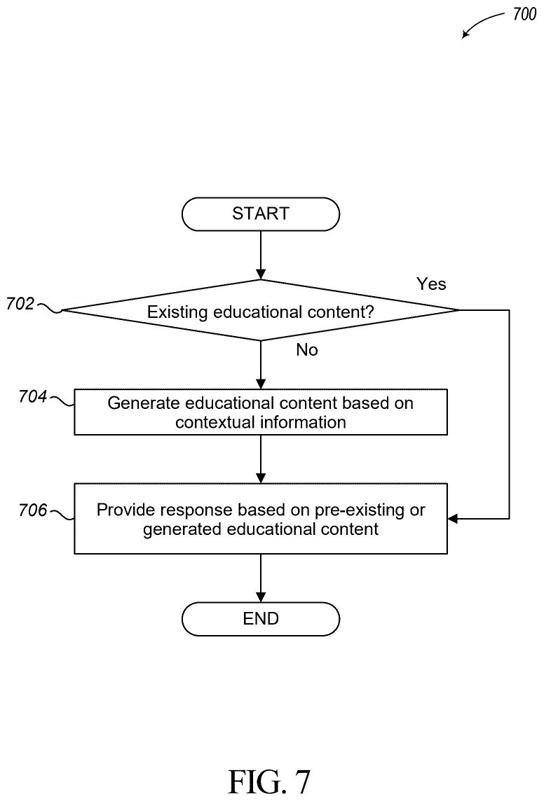

FIG. 7 illustrates a logical flow diagram showing one embodiment of a process 700 for generating contextual educational content in accordance with embodiments described herein. In some embodiments, block 306 of FIG. 3 employs embodiments of process 702 to create a prompt for educational artificial intelligence model based on contextual information.

Process 700 begins, after a start block, at decision block 702, where a determination is made whether existing educational content responsive to a prompt is available. In some embodiments, the determination is made by comparing contextual information to corresponding information associated with educational content in an educational content database. If existing educational content is available, process 700 continues to block 706. If existing content is not available, process 700 continues to block 704.

At block 704, educational content is generated based on contextual information. In various embodiments, block 704 employs process 300 of FIG. 3 to generate the educational content based on the contextual information.

In some embodiments, process 700 is implemented using instructions in a prompt to be provided to the educational AI model. For example, the prompt to be provided to the educational AI model may include a command summarizing process 700 such as “check whether existing educational content may be used to answer the query before generating new educational content.”

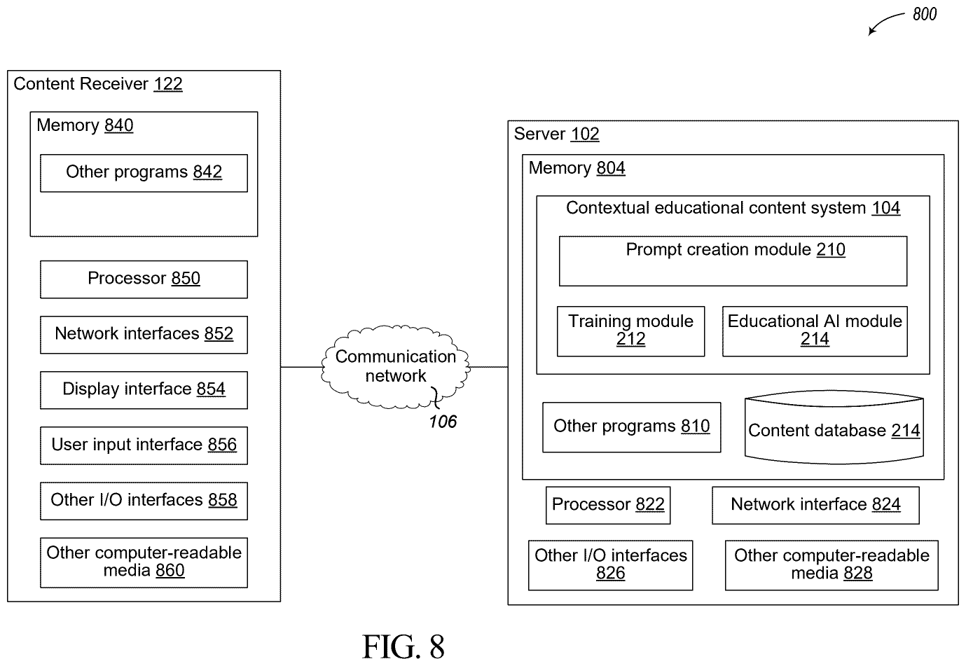

FIG. 8 shows a system diagram 800 that describes computing systems for implementing embodiments described herein.

As described herein, server 102 is a computing device that can perform functionality described herein for providing contextual educational content for a content receiver using artificial intelligence. One or more special purpose computing systems may be used to implement the server 102. Accordingly, various embodiments described herein may be implemented in software, hardware, firmware, or in some combination thereof. Server 102 includes memory 804, one or more processors 822, network interface 824, other input/output (I/O) interfaces 826, and other computer-readable media 828. In various embodiments, server 102 is implemented using cloud computing resources, in a virtual machine, or by any other known technique.

Processor 822 includes one or more processors, processing units, programmable logic, circuitry, or other computing components that are configured to perform embodiments described herein or to execute computer instructions to perform embodiments described herein. In some embodiments, processor 822 may include a single processor that operates individually to perform actions. In other embodiments, processor 822 may include a plurality of processors that operate to collectively perform actions, such that one or more processors may operate to perform some, but not all, of such actions. Reference herein to “a processor” refers to one or more processors 822 that individually or collectively perform actions.

Memory 804 may include one or more various types of non-volatile or volatile storage technologies. Examples of memory 804 include, but are not limited to, flash memory, hard disk drives, optical drives, solid-state drives, various types of random-access memory (“RAM”), various types of read-only memory (“ROM”), other computer-readable storage media (also referred to as processor-readable storage media), or other memory technologies, or any combination thereof. Memory 804 may be utilized to store information, including computer-readable instructions that are utilized by processor 822 to perform actions, including at least some embodiments described herein.

Memory 804 may have stored thereon contextual educational content system 104. Contextual educational content system 104 includes prompt creation module 210, training module 212, and educational AI module 214. Prompt creation model provides for creating prompts requesting educational content from educational AI module 214. Training module 212 provides for training the educational AI module 214. Educational AI module 214 provides for automatically creating educational content based on a prompt created by prompt creation module 210. While prompt creation module 210, training module 212, and educational AI module 214 are illustrated as stored in memory 804, in various embodiments, one or more of prompt creation module 210, training module 212, or educational AI module 214 is implemented using a computing device besides server 102 such as content receiver 122.

Memory 804 may also store other programs 810, which may include operating systems, user applications, or other computer programs.

Network interfaces 824 are configured to communicate with other computing devices, such as content receiver 122, via the communication network 106. Network interfaces 824 include transmitters and receivers (not illustrated) to send and receive data from content receiver 122 or other devices.

Other I/O interfaces 826 may include interfaces for various other input or output devices, such as audio interfaces, other video interfaces, USB interfaces, physical buttons, keyboards, haptic interfaces, tactile interfaces, or the like. Other computer-readable media 828 may include other types of stationary or removable computer-readable media, such as removable flash drives, external hard drives, or the like.

Memory 840, processor 850, network interfaces 852, other I/O interfaces 858, and other computer-readable media 860 of content receiver 122 are in various embodiments similar to corresponding components discussed with respect to server 102.

Memory 840 may have stored thereon other programs 842, which may include operating systems, user applications, or other computer programs.

Display interface 854 may provide for outputting content to a display.

User input interfaces 856 may include interfaces for various user inputs, such as inputs received via a remote control, cell phone, etc.

The following is a summary of the claims as originally filed.

A method may be summarized as including: obtaining contextual information associated with content currently displayed to a user using a content receiver; determining to provide, to the user, educational content regarding the content receiver; creating, based on the contextual information, a prompt for an educational artificial intelligence model; providing the prompt to the educational artificial intelligence model; causing educational content to be displayed to the user based on output from the educational artificial intelligence model; and training the educational artificial intelligence model based on user input received in response to displaying the educational content.

Determining to provide educational content regarding the content receiver may include receiving, from the user, a request for educational content regarding the content receiver.

Determining to provide educational content regarding the content receiver may include detecting an action of the user that indicates that the user requires educational content to control the content receiver.

Determining to provide educational content regarding the content receiver may include: obtaining action data that indicates an action of the user; creating, using the action data, a prompt to query a detection artificial intelligence model to determine whether the action of the user indicates that the user requires educational content to control the content receiver; providing the prompt to the detection artificial intelligence model; and determining to provide the educational content based on output from the detection artificial intelligence model.

Training the educational artificial intelligence model based on user input received in response to displaying the educational content may include: creating, based on the user input, a feedback prompt to query a feedback artificial intelligence model to determine a level of satisfaction of the user with the educational content; providing the feedback prompt to the feedback artificial intelligence model; and training the educational artificial intelligence model based on output of the feedback artificial intelligence model.

The method may further include: creating, based on the user input, a feedback prompt for a feedback artificial intelligence model to determine a level of satisfaction of the user with the displayed instructional content; providing the feedback prompt to the feedback artificial intelligence model; and creating a subsequent prompt for the educational artificial intelligence model based on output of feedback artificial intelligence model.

Obtaining contextual information associated with content currently displayed to the user may include obtaining contextual information that includes a notification currently displayed to the user.

Creating the prompt for the educational artificial intelligence model may include: including in the prompt, one or more instructions to format the response in a specified style.

Creating the prompt for the educational artificial intelligence model may include: including, in the prompt, one or more instructions that direct the educational artificial intelligence model to perform actions including: attempting to obtain existing educational content regarding the content receiver based on the contextual information; and causing the educational content to be displayed based on the existing educational content.

Creating the prompt for the educational artificial intelligence model may include: including, in the prompt, one or more instructions that direct the educational artificial intelligence model to perform actions comprising: attempting to obtain existing educational content regarding the content receiver based on the contextual information; in response to failing to locate existing educational content based on the contextual information, generating educational content responsive to the contextual information; and causing the educational content to be displayed based on the generated educational content.

Creating the prompt for the educational artificial intelligence model may include: obtaining user support interactions, wherein each user support interaction includes contextual information regarding a content receiver; comparing the contextual information to one or more user support interactions; selecting, based on the comparison, a user support interaction of the one or more user support interactions; and creating the prompt based on the selected user support interaction.

Creating the prompt for the educational artificial intelligence model may include: obtaining call center interaction embeddings based on call center interactions; creating an embedding of the contextual information; comparing the embedding of the contextual information to each call center interaction embedding; selecting, based on the comparison, one or more call center interaction embeddings to include in the prompt; and creating the prompt based on the one or more call center interaction embeddings.

Creating the prompt for the educational artificial intelligence model may include: obtaining educational content regarding the content receiver; creating an embedding of the educational content; and creating the prompt using the embedding of the educational content.

The method may further include: after changing a state of the content receiver in response to educational content displayed to the user, obtaining user input requesting a state of the content receiver be reverted to a backup state; and causing the state of the content receiver to be reverted to the backup state.

Causing educational content to be displayed to the user based on output from the educational artificial intelligence model may include: causing the content receiver to enter a learning mode wherein the educational content is displayed alongside the content currently displayed to the user; and in response to detecting user input that indicates that the user understands the educational content, causing the content receiver to exit the learning mode.

A system may be summarized as including: one or more memories configured to collectively store instructions; one or more processors configured to collectively execute the stored instructions to: determine to provide, to a user, an educational animation regarding a content receiver; obtain contextual information associated with a current state of the content receiver; obtain one or more renderings of a control device for the content receiver; create, based on the contextual information and the one or more renderings of the control device, a prompt for an educational artificial intelligence model that requests the educational animation; provide the prompt to the educational artificial intelligence model; and cause the educational animation to be displayed to the user based on output from the educational artificial intelligence model.

The one or more processors may create the prompt for the educational artificial intelligence model by being further configured to: obtain user support interactions, wherein each user support interaction includes contextual information regarding a content receiver; compare the contextual information to each user support interaction of the plurality of user support interactions; select, based on the comparison, one or more user support interactions of the plurality of user support embeddings to include in the prompt; and create the prompt based on the one or more user support interactions.

The one or more processors may determine to provide educational content regarding the content receiver by being further configured to: obtain action data that indicates an action of the user; create, using the action data, a prompt to query a detection artificial intelligence model to determine whether the action of the user indicates that the user requires educational content to control the content receiver; provide the prompt to the detection artificial intelligence model; and determine to provide the educational content based on output from the detection artificial intelligence model.

One or more non-transitory computer-readable media that collectively store instructions executable by a processor to perform actions, the actions may be summarized as including: obtaining contextual information associated with content currently displayed to the user using a content receiver; creating, based on the contextual information, a prompt for an educational artificial intelligence model; providing the prompt to the educational artificial intelligence model; causing educational content to be displayed to the user based on output from the educational artificial intelligence model; and training the educational artificial intelligence model based on user input received in response to displaying the educational content.

The one or more non-transitory computer-readable media may further storing instructions executable to create the prompt for the educational artificial intelligence model by: obtaining educational information regarding the content receiver; comparing the contextual information to the educational information; selecting, based on the comparison, a portion of the educational information to include in the prompt; and creating the prompt based on the portion of the educational information.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
obtaining contextual information associated with content currently displayed to a user using a content receiver;
determining to provide, to the user, educational content regarding the content receiver;
creating, based on the contextual information, a prompt for an educational artificial intelligence model;
providing the prompt to the educational artificial intelligence model;
causing educational content to be displayed to the user based on output from the educational artificial intelligence model; and
training the educational artificial intelligence model based on user input received in response to displaying the educational content.

2. The method of claim 1, wherein determining to provide educational content regarding the content receiver comprises:
receiving, from the user, a request for educational content regarding the content receiver.

3. The method of claim 1, wherein determining to provide educational content regarding the content receiver comprises:
detecting an action of the user that indicates that the user requires educational content to control the content receiver.

4. The method of claim 1, wherein determining to provide educational content regarding the content receiver comprises:
obtaining action data that indicates an action of the user;
creating, using the action data, a prompt to query a detection artificial intelligence model to determine whether the action of the user indicates that the user requires educational content to control the content receiver;
providing the prompt to the detection artificial intelligence model; and
determining to provide the educational content based on output from the detection artificial intelligence model.

5. The method of claim 1, wherein training the educational artificial intelligence model based on user input received in response to displaying the educational content comprises:
creating, based on the user input, a feedback prompt to query a feedback artificial intelligence model to determine a level of satisfaction of the user with the educational content;
providing the feedback prompt to the feedback artificial intelligence model; and
training the educational artificial intelligence model based on output of the feedback artificial intelligence model.

6. The method of claim 1, further comprising:
creating, based on the user input, a feedback prompt for a feedback artificial intelligence model to determine a level of satisfaction of the user with the displayed instructional content;
providing the feedback prompt to the feedback artificial intelligence model; and
creating a subsequent prompt for the educational artificial intelligence model based on output of the feedback artificial intelligence model.

7. The method of claim 1, wherein obtaining contextual information associated with content currently displayed to the user comprises:
obtaining contextual information that includes a notification currently displayed to the user.

8. The method of claim 1, wherein creating the prompt for the educational artificial intelligence model comprises:
including, in the prompt, one or more instructions to format the response in a specified style.

9. The method of claim 1, wherein creating the prompt for the educational artificial intelligence model comprises:
including, in the prompt, one or more instructions that direct the educational artificial intelligence model to perform actions comprising:
attempting to obtain existing educational content regarding the content receiver based on the contextual information; and
causing the educational content to be displayed based on the existing educational content.

10. The method of claim 1, wherein creating the prompt for the educational artificial intelligence model comprises:
including, in the prompt, one or more instructions that direct the educational artificial intelligence model to perform actions comprising:
attempting to obtain existing educational content regarding the content receiver based on the contextual information;
in response to failing to locate existing educational content based on the contextual information, generating educational content responsive to the contextual information; and
causing the educational content to be displayed based on the generated educational content.

11. The method of claim 1, wherein creating the prompt for the educational artificial intelligence model comprises:
obtaining a plurality of user support interactions, wherein each user support interaction in the plurality of user support interactions includes contextual information regarding a content receiver;
comparing the contextual information to one or more user support interactions of the plurality of user support interactions;
selecting, based on the comparison, a user support interaction of the one or more user support interactions; and
creating the prompt based on the selected user support interaction.

12. The method of claim 1, wherein creating the prompt for the educational artificial intelligence model comprises:
obtaining a plurality of call center interaction embeddings based on a plurality of call center interactions;
creating an embedding of the contextual information;
comparing the embedding of the contextual information to each call center interaction embedding in the plurality of call center interaction embeddings;
selecting, based on the comparison, one or more call center interaction embeddings of the plurality of call center interaction embeddings to include in the prompt; and
creating the prompt based on the one or more call center interaction embeddings.

13. The method of claim 1, wherein creating the prompt for the educational artificial intelligence model comprises:
obtaining educational content regarding the content receiver;
creating an embedding of the educational content; and
creating the prompt using the embedding of the educational content.

14. The method of claim 1, further comprising:
after changing a state of the content receiver in response to educational content displayed to the user, obtaining user input requesting a state of the content receiver be reverted to a backup state; and
causing the state of the content receiver to be reverted to the backup state.

15. The method of claim 1, wherein causing educational content to be displayed to the user based on output from the educational artificial intelligence model comprises:
causing the content receiver to enter a learning mode wherein the educational content is displayed alongside the content currently displayed to the user; and
in response to detecting user input that indicates that the user understands the educational content, causing the content receiver to exit the learning mode.

16. A system comprising:
one or more memories configured to collectively store instructions;
one or more processors configured to collectively execute the stored instructions to:
determine to provide, to a user, an educational animation regarding a content receiver;
obtain contextual information associated with a current state of the content receiver;
obtain one or more renderings of a control device for the content receiver;
create, based on the contextual information and the one or more renderings of the control device, a prompt for an educational artificial intelligence model that requests the educational animation;
provide the prompt to the educational artificial intelligence model; and
cause the educational animation to be displayed to the user based on output from the educational artificial intelligence model.

17. The system of claim 16, wherein the one or more processors create the prompt for the educational artificial intelligence model by being further configured to:
obtain a plurality of user support interactions, wherein each user support interaction in the plurality of user support interactions includes contextual information regarding a content receiver;
compare the contextual information to each user support interaction of the plurality of user support interactions;
select, based on the comparison, one or more user support interactions of the plurality of user support embeddings to include in the prompt; and
create the prompt based on the one or more user support interactions.

18. The system of claim 16, wherein the one or more processors determine to provide educational content regarding the content receiver by being further configured to:
obtain action data that indicates an action of the user;
create, using the action data, a prompt to query a detection artificial intelligence model to determine whether the action of the user indicates that the user requires educational content to control the content receiver;
provide the prompt to the detection artificial intelligence model; and
determine to provide the educational content based on output from the detection artificial intelligence model.

19. One or more non-transitory computer-readable media that collectively store instructions executable by a processor to perform actions, the actions comprising:
obtaining contextual information associated with content currently displayed to the user using a content receiver;
creating, based on the contextual information, a prompt for an educational artificial intelligence model;
providing the prompt to the educational artificial intelligence model;
causing educational content to be displayed to the user based on output from the educational artificial intelligence model; and
training the educational artificial intelligence model based on user input received in response to displaying the educational content.

20. The one or more non-transitory computer-readable media of claim 19, further storing instructions executable to create the prompt for the educational artificial intelligence model by:
obtaining educational information regarding the content receiver;
comparing the contextual information to the educational information;
selecting, based on the comparison, a portion of the educational information to include in the prompt; and
creating the prompt based on the portion of the educational information.
